(19) United States
(12) Patent Application Publication
(10) Pub. No.: US 2017/0364171 A1
(43) Pub. Date: Dec. 21, 2017

(54) Touch Panel

(71) Applicant: LG INNOTEK CO., LTD., Seoul (KR)

(72) Inventors: Young Sun YOU, Seoul (KR); Jin Woong LEE, Seoul (KR); Kwang Yong JIN, Seoul (KR); Seong Su EOM, Seoul (KR); Chung Wan LEE, Seoul (KR); Yong Jae CHOI, Seoul (KR)

(21) Appl. No.: 15/548,384

(22) PCT Filed: Feb. 2, 2016
(86) PCT No.: PCT/KR2016/001119

§ 371 Date: Aug. 2, 2017

(30) Foreign Application Priority Data
Feb. 2, 2015 (KR) 10-2015-0016328
Feb. 2, 2015 (KR) 10-2015-0016329

(51) Int. Cl. G06F 3/041; G02F 1/1333; G02F 1/1343

(52) U.S. Cl. CPC G06F 3/041; G02F 1/1343; G02F 1/13338; G06F 2203/04112

(57) ABSTRACT

The present invention relates to a touch panel and, more specifically, to a touch panel comprising: a substrate having an effective region and a non-effective region; a sensing electrode and a touch electrode formed in the effective region on the substrate; a wiring electrode formed in the non-effective region on the substrate and connected to the sensing electrode; a touch wiring electrode formed in the non-effective region on the substrate and connected to the touch electrode; and a coil part formed in the non-effective region on the substrate.

### TECHNICAL FIELD

The present invention relates to a touch panel and, more particularly, to a touch panel capable of a touch input although the input means of a touch panel does not include a separate power source.

### BACKGROUND ART

Recently, a touch panel in which input is performed in such a manner that an input device, such as a finger or a stylus, touches an image displayed on a display device is applied to various electronic products.

The touch panel may be representatively divided into a resistive film type touch panel and a capacitive type touch panel. In the resistive film type touch panel, a location is detected by sensing a change in resistance depending on a connection between electrodes when pressure is applied to an input device. In the capacitive type touch panel, a location is detected by sensing a change in capacitance between electrodes when a finger is touched. The capacitive type has recently been in the spotlight in a small model by taking into consideration convenience in a manufacturing method, sensing power, etc.

The touch panel includes a substrate including an invalid area and a valid area. A transparent electrode sending input means is formed in the valid area, and a wiring, a dummy layer, etc., are formed in the invalid area.

The aforementioned capacitive type chiefly includes a configuration including two capacitive sensing layers. The two capacitive sensing layers are made of an insulating material with a space interposed therebetween in order to obtain a capacitive effect between the layers.

Meanwhile, conventionally, in order to perform input on a touch panel using a stylus pen, a power source must be included in the stylus pen. Accordingly, the size of the stylus pen is increased, and inconvenience in which the stylus pen can be used only when power is charged is caused.

Prior Art Document—(Patent Document 1) Korean Patent Application Publication No. 2014-0040431

### DISCLOSURE

### Technical Problem

The present invention has been made to solve the above problems, and an object of the present invention is to provide a touch panel providing power so that a touch device can be used using a stylus pen even without including a power source in the stylus pen.

### Technical Solution

A touch panel of the present invention for solving the object includes a substrate having a valid area and an invalid area, a sensing electrode and touch electrode formed in the valid area of the substrate, a wiring electrode formed in the invalid area of the substrate and connected to the sensing electrode, a touch wiring electrode formed in the invalid area of the substrate and connected to the touch electrode, and a coil part formed in the invalid area of the substrate. In this case, at least any one of the sensing electrode, the touch electrode, the wiring electrode, the touch wiring electrode and the coil part may have a conductive pattern, and the conductive pattern includes mesh lines and mesh opening parts.

In an embodiment of the present invention, the substrate includes a first substrate on which a first sensing electrode and a first touch electrode are formed and a second substrate on which a second sensing electrode and a second touch electrode are formed. In this case, a cover substrate on which a dummy layer is formed in the invalid area may be further included. Alternatively, a dummy layer may be formed in the invalid area of the first substrate, and the wiring electrode or the touch wiring electrode may be formed over the dummy layer. The coil part is formed under the dummy layer or formed to not overlap the wiring electrode and the touch wiring electrode over the dummy layer. In another embodiment, a first sensing electrode and a first touch electrode may be formed on one surface of the substrate, and a second sensing electrode and a second touch electrode may be formed on the other surface of the substrate.

In an embodiment of the present invention, the sensing electrode, the touch electrode and the coil part may be made of the same electrode material, the height of the coil part may be identical with the height of the sensing electrode or the touch electrode, and the width of the coil part may be greater than the width of the sensing electrode or touch electrode.

Meanwhile, the coil part may be formed on at least one of a surface on which the first sensing electrode and the first touch electrode are formed on the first substrate and a surface on which the second sensing electrode and the second touch electrode are formed on the second substrate. Furthermore, a coil substrate which is coupled to the substrate and on which the coil part has been formed in the invalid area may be further included. The coil part may include a plurality of loops.

### ADVANTAGEOUS EFFECTS

In accordance with the present invention, a touch device can be used using a stylus pen even without driving power in the stylus pen.

In particular, power can be supplied to a stylus pen by applying the coil part to touch panels of various forms.

### DESCRIPTION OF DRAWINGS

FIGS. 1 to 6 are cross-sectional views of a touch panel according to various embodiments of the present invention.

FIG. 7 is a flowchart schematically showing a method of manufacturing a touch panel according to another embodiment of the present invention.

FIG. 8 is a side view schematically showing a touch panel in which a coil part has been formed according to another embodiment of the present invention.

FIG. 9 is a side view schematically showing a touch panel in which a coil part has been formed according to yet another embodiment of the present invention.

FIGS. 10 to 13 are diagrams showing examples to which the touch panel has been applied according to various embodiments of the present invention.

### MODE FOR INVENTION

Hereinafter, touch panels according to the present invention are described in detail with reference to the accompanying drawings. Embodiments described hereunder are provided in order for a person having ordinary skill in the art to easily understand the technological spirit of the present invention, and the present invention is not restricted by the embodiments. Furthermore, contents expressed in the accompanying drawings have been diagrammed to easily describe the embodiments of the present invention, and may be different from those that are actually implemented.

Meanwhile, an expression that some elements are “included” is an expression of an “open type”, and the expression simply denotes that the corresponding elements are present, but should not be construed as excluding additional elements.

Furthermore, expressions, such as “the first” and “the second”, are expressions used to only distinguish a plurality of elements from one another and do not limit the sequence or other characteristics of the elements.

A touch panel includes a substrate in which a valid area VA where the location of an input device (e.g., a finger) is sensed and an invalid area UA disposed around the valid area VA are defined.

In this case, a transparent electrode may be formed in the valid area VA so that the input device can be sensed. Furthermore, a wiring electrically connected to the transparent electrode may be formed in the invalid area UA. Furthermore, an external circuit, etc. connected to the wiring may be located in the invalid area UA. A dummy layer may be formed in the invalid area UA. A logo, etc., may be formed in the dummy layer.

When the input device touches the touch panel, a difference in capacitance is generated from a portion touched by the input device. The portion from which such a difference is generated is detected as a contact location.

Such a touch panel is described in more detail below.

The substrate supports a sensing electrode, an insulating layer, a wiring electrode, a circuit substrate, etc. formed over the substrate. The substrate may be formed using various materials. For example, the substrate may be formed using a glass substrate or a plastic substrate. The substrate may be the cover substrate of a mobile phone or other electronic devices, but does not exclude that it is a substrate provided separately from the cover substrate.

The substrate includes the valid area VA and the invalid area UA surrounding the valid area. The dummy layer is formed in the invalid area UA of the substrate. The dummy layer may be formed by coating a material having a specific color so that a wiring electrode and a printed circuit board connecting the wiring electrode to an external circuit are not visible from the outside. The dummy layer may have a color suitable for a desired external appearance. For example, the dummy layer may include a black pigment or white pigment and display black or white. Furthermore, a desired logo, etc. may be formed in the dummy layer in various ways.

That is, the dummy layer may be formed in the invalid area UA using the black pigment or the white pigment. In this case, if the white pigment is used, the white layer may be formed. If the black pigment is used, the black layer may be formed. In this case, the white pigment includes a transparent pigment.

The sensing electrode may include a transparent conductive material so that electricity can flow while not hindering the transmission of light. For example, the sensing electrode may include metal oxide, such as indium tin oxide, indium zinc oxide, copper oxide, tin oxide, zinc oxide or titanium oxide. Alternatively, the sensing electrode may include a nanowire, a photosensitive nanowire film, carbon nanotube (CNT), graphene or conductive polymer. Alternatively, the sensing electrode may include various types of metal. For example, the sensing electrode may include at least one of pieces of metal, such as chrome (Cr), nickel (Ni), copper (Cu), aluminum (Al), silver (Ag), molybdenum (Mo), gold (Au), titanium (Ti) and an alloy of them. Furthermore, the sensing electrode may include metal having excellent electrical conductivity.

A touch electrode may also include a transparent conductive material so that electricity can flow while not hindering the transmission of light, and senses a touch input generated by input means, such as a stylus pen. The touch electrode may include the same metal oxide, metal, nanowire, photosensitive nanowire film, carbon nanotube (CNT), graphene or conductive polymer as the listed materials that form the sensing electrode.

The wiring electrode is formed in the invalid area of the substrate, and is an element, that is, a medium which sends an electric signal sensed by the sensing electrode to the driver IC, etc. of the touch panel. The wiring electrode may include metal having excellent electrical conductivity. For example, the wiring electrode may include metal oxide, such as indium tin oxide, indium zinc oxide, copper oxide, tin oxide, zinc oxide or titanium oxide, and may also include a nanowire, a photosensitive nanowire film, carbon nanotube (CNT), graphene or conductive polymer. Furthermore, the wiring electrode may include various types of metal. For example, the wiring electrode may include at least one of chrome (Cr), nickel (Ni), copper (Cu), aluminum (Al), silver (Ag), molybdenum (Mo), gold (Au), titanium (Ti) and an alloy of them. The wiring electrode may be formed over the dummy layer in the invalid area of the substrate.

The touch wiring electrode is also formed in the invalid area of the substrate, and sends an electric signal sensed by the touch electrode to the driver IC, etc. of the touch panel. The touch wiring electrode may be formed using the aforementioned various materials that form the wiring electrode.

At least one of the sensing electrode, touch electrode, wiring electrode, touch wiring electrode and coil part of the present invention may have a conductive pattern. The conductive pattern may be formed in a mesh structure having mesh lines and mesh opening parts.

The electrodes may include a plurality of sub-electrodes. The sub-electrodes may be disposed to cross each other in a mesh form. Specifically, the mesh lines LA and the mesh opening part OA between the mesh lines LA may be formed by the plurality of sub-electrodes crossing each other in the mesh form. The line width of the mesh line LA may be about 0.1 μm to about 10 μm. A mesh line part in which the line width of the mesh line LA is less than about 0.1 μm is impossible in the manufacturing process or the short-circuiting of mesh lines may be generated in such a mesh line part. If the line width exceeds about 10 μm, visibility may be deteriorated because an electrode pattern is visible from the outside. Preferably, the line width of the mesh line LA may be about 0.5 μm to about 7 μm. More preferably, the line width of the mesh line may be about 1 μm to about 3.5 μm.

Furthermore, the mesh opening part may be formed in various shapes. For example, the mesh opening part OA may have various shapes such as a polygon shape, such as a quadrangle, diamond shape, pentagon and hexagon, or a circle. Furthermore, the mesh opening part may be formed in a regular shape or a random shape.

Since the electrode has the mesh form, the pattern of the sensing electrode is not visible in the valid area, for example, on a display area. That is, although the sensing electrode is made of metal, a pattern may not be visible. Furthermore, although the sensing electrode is applied to a large-sized touch panel, resistance of the touch panel can be lowered.

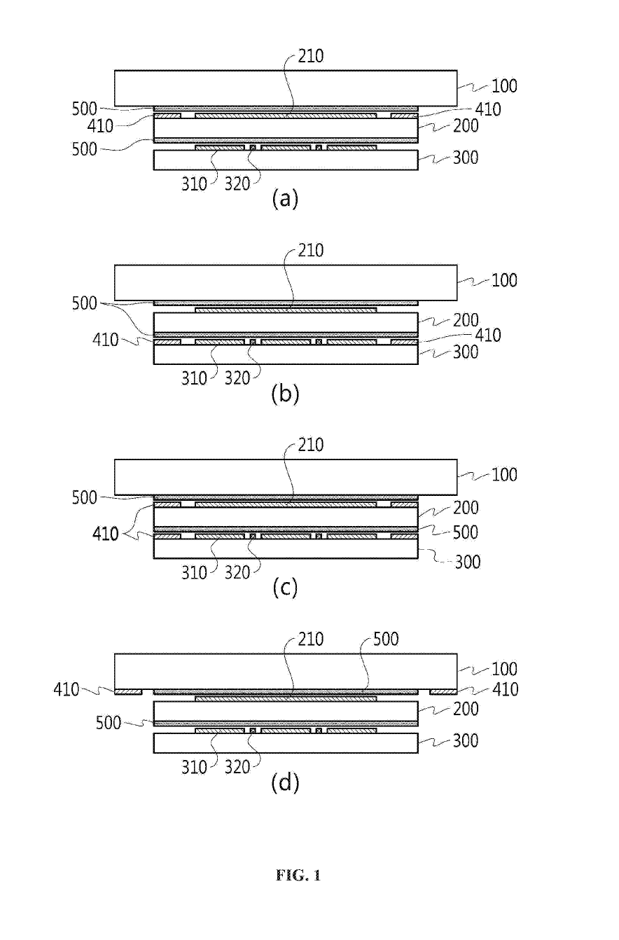

FIG. 1 is a cross-sectional view of a touch panel according to an embodiment of the present invention.

The touch panel according to an embodiment of the present invention includes a substrate having a valid area and an invalid area, a sensing electrode and touch electrode formed in the valid area of the substrate, a wiring electrode formed in the invalid area of the substrate and connected to the sensing electrode, a touch wiring electrode formed in the invalid area of the substrate and connected to the touch electrode, and a coil part formed in the invalid area of the substrate.

The present invention is different from a conventional technology in that the coil part is formed over the substrate. The coil part 410 is an element for supplying power to a stylus pen, that is, the input means of the touch panel. As described above, conventionally, a power unit was separately included in the stylus pen, and the stylus pen was driven by power supplied by the power unit. In the present invention, however, the coil part 410 supplies power to the stylus pen, the stylus pen is driven by the supplied power, and thus the input of the stylus pen can be sensed in a battery-less form.

The coil part 410 is formed of one or more electrode loops. More specifically, the coil part is formed according to a shape of the touch panel or along the boundary of the invalid area and the valid area or in various closed loop forms in the invalid area of the touch panel. When the stylus pen approaches a surface of the touch panel, a magnetic flux within the coil part 410 is changed, so an induction current is generated in a coil included in the stylus pen according to the electromagnetic induction principle. The stylus pen may be driven by the induced current.

In an embodiment of the present invention, the substrate may include a first substrate 200 having a first sensing electrode and a first touch electrode formed therein and a second substrate 300 having a second sensing electrode and a second touch electrode formed therein. In this case, the substrate may further include a cover substrate 100 having the dummy layer formed in the invalid area. The present embodiment is shown in FIG. 1. In this case, the wiring electrode and the touch wiring electrode are formed in an area in which the dummy layer has been formed in the invalid area of the first substrate and the second substrate. The coil part 410 may be formed in the invalid area of at least one of the cover substrate 100, the first substrate 200 and the second substrate 300. In a more detailed embodiment, the coil part 410 may be formed on at least one of a surface on which the first sensing electrode 210 has been formed over the first substrate 200, a surface on which the second sensing electrode 310 has been formed over the second substrate 300, and one surface of the cover substrate 100 on which the cover substrate 100 is coupled to the first substrate 200.

FIG. 1(a) is a cross-sectional view showing an example in which the coil part 410 has been formed in the invalid area of a surface that belongs to the first substrate 200 and on which the first sensing electrode 210 has been formed. FIG. 1(b) is a cross-sectional view showing an example in which the coil part 410 has been formed in the invalid area of a surface that belongs to the second substrate 300 and on which the second sensing electrode 310 has been formed. Meanwhile, FIG. 1(c) is a cross-sectional view showing an example in which the coil parts 410 are formed on both the first and the second substrates. Even in this case, the coil part 410 may be formed on surfaces on which the first and the second sensing electrodes have been formed. FIG. 1(d) is an example in which the coil part 410 has been formed on the cover substrate 100. Specifically, the coil part 410 has been formed in the invalid area of one surface (the bottom of the cover substrate 100 in FIG. 1(d)) that belongs to the cover substrate 100 and on which the cover substrate 100 and the first substrate 200 are coupled.

In addition, the coil part 410 has been formed on all of the first and the second substrates and the cover substrate 100. That is, an example in which the coil part 410 has been formed on at least one of the first and the second substrates and the cover substrate 100 should be considered to be the scope of the present invention. Meanwhile, each coil part 410 may also be formed of a plurality of loops. If a plurality of the coil parts 410 is formed or each of the coil parts 410 is formed of a plurality of loops, the number of turns of the coil loop that transfers power to a stylus pen is increased, thereby being capable of inducing more current. Accordingly, the number of coil parts 410 may be determined by taking into consideration a design factor, such as the amount of current for driving a stylus pen. The coil part may be formed under the dummy layer or may be formed over the dummy layer.

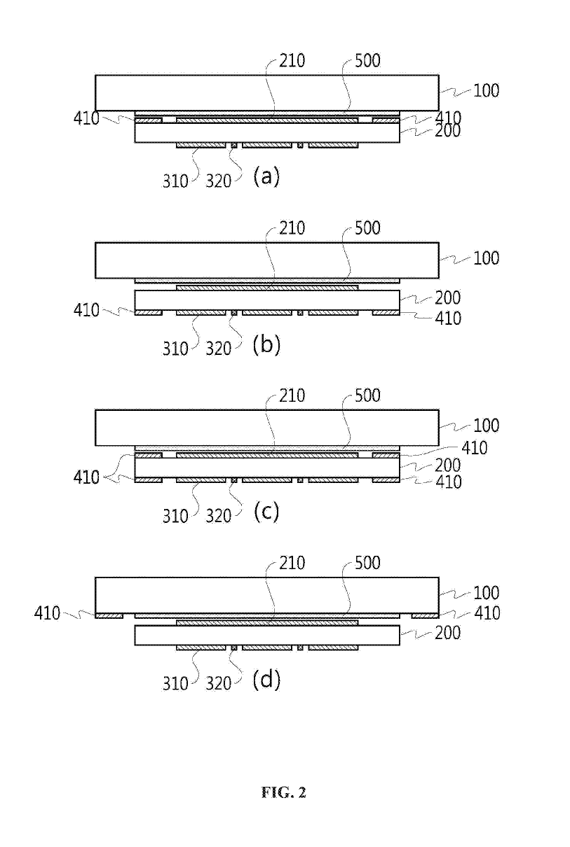

Meanwhile, in another embodiment of the present invention, the first sensing electrode and the first touch electrode may be formed on one surface of the substrate 200, and the second sensing electrode and the second touch electrode may be formed on the other surface of the substrate. The present embodiment is described with reference to FIG. 2. In the present embodiment, unlike in the aforementioned embodiment, the first and the second sensing electrodes and the first and the second touch electrodes are formed on a single substrate. More specifically, the first sensing electrode 210 and the first touch electrode 220 are formed on one surface of the first substrate 200 in a first direction, and the second sensing electrode 310 and the second touch electrode 320 are formed on the other surface of the first substrate 200 in a second direction.

Even in such a structure, the coil part 410 may be formed in the invalid area of at least one of the cover substrate 100 and the first substrate 200. More specifically, the coil part 410 may be formed on at least one of the top surface of the first substrate 200, the bottom surface of the first substrate 200, and one surface of the cover substrate 100 on which the cover substrate 100 is coupled to the first substrate 200. FIG. 2(a) is an example in which the coil part 410 has been formed on the top surface of the first substrate 200 on which the first sensing electrode 210 and the first touch electrode 220 have been formed. FIG. 2(b) is an example in which the coil part 410 has been formed on the bottom surface of the second substrate 300 on which the second sensing electrode 310 and the second touch electrode 320 have been formed. Meanwhile, FIG. 2(c) is an example in which the coil part 410 has been formed on both the top/bottom surfaces of the first substrate 200. In FIG. 2(d), the coil part 410 is formed on one surface of the cover substrate 100, specifically, on one surface of the cover substrate 100 to which the first substrate 200 is coupled. Meanwhile, although not shown, the coil part 410 may be formed on all of the top/bottom surfaces of the first substrate 200 and the cover substrate 100.

In the present embodiment, an adhesive layer 500 may be formed between the cover substrate 100 and the first substrate 200, and the first substrate 200 and the cover substrate 100 may be coupled through the medium of the adhesive layer 500. The coil part may be formed under the dummy layer or may be formed over the dummy layer.

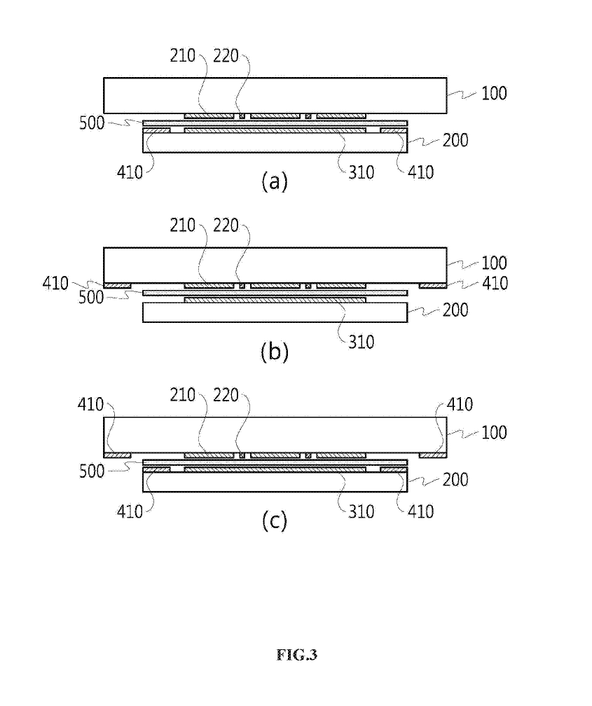

In another embodiment of the present invention, the dummy layer may be formed in the invalid area of the first substrate and the wiring electrode or the touch wiring electrode may be formed over the dummy layer. The present embodiment is described with reference to FIG. 3. In the present embodiment, unlike in the embodiments described with reference to FIGS. 1 and 2, the first substrate functions as a cover substrate. Specifically, the first sensing electrode 210 and the first touch electrode 220 are formed in the valid area on one surface of the first substrate 100 coupled to the second substrate. Furthermore, the second sensing electrode 310 and the second touch electrode 320 are formed on the second substrate 200, and the coil part 410 is formed on at least one of the first substrate and the second substrate. In this case, the coil part 410 may be formed in the invalid area of a surface that belongs to the first substrate or the second substrate and on which the sensing electrode/touch electrode have been formed. The coil part 410 may be formed on at least one of the first substrate and the second substrate. FIG. 3(a) is an example in which the coil part 410 has been formed on a surface that belongs to the second substrate and on which the sensing electrode/touch electrode have been formed. FIG. 3(b) is an example in which the coil part 410 has been formed on a surface that belongs to the first substrate and on which the sensing electrode/touch electrode have been formed. FIG. 3(c) is an example in which the coil part 410 has been formed on all of the first substrate and the second substrate.

Meanwhile, the coil part may be formed under the dummy layer or may be formed to not overlap the wiring electrode and the touch wiring electrode over the dummy layer.

Even in the present embodiment, the first substrate and the second substrate may be coupled through the medium of the adhesive layer 500. The sensing electrode/touch electrode formed on the first substrate and the sensing electrode/touch electrode formed on the second substrate may be insulated by the adhesive layer 500. Accordingly, a touch location in each of the first and the second directions can be sensed, and a two-dimensional touch location can be sensed using the sensed touch location.

Meanwhile, in an embodiment of the present invention, the coil part 410 formed on a substrate may be formed on the same surface as a surface on which the first sensing electrode 210 and the first touch electrode 220 are formed or on which the second sensing electrode 310 and the second touch electrode 320 are formed. A touch panel of such a shape has an advantage in that it can reduce a manufacturing process. The sensing electrode, the touch electrode and the coil part 410 may be formed using a metal material having good electrical conductivity. In particular, in an embodiment of the present invention, the coil part 410 may be formed using the same electrode material as a sensing electrode or a touch electrode. The electrode materials of the sensing electrode and the touch electrode have been described above and are not described redundantly.

In a process of forming a sensing electrode or a touch electrode, more specifically, a process of printing a sensing electrode and a touch electrode on the first substrate 200 or the second substrate 300, if even the coil part 410 is printed in the invalid area, all of the sensing electrode, the touch electrode and the coil part 410 may be formed through one process. If the coil part 410 is formed on an opposite surface that belongs to a substrate and on which a sensing electrode and a touch electrode have not been formed, a process for forming the coil part 410 has to be additionally performed. If the coil part 410 is formed on the same surface of a substrate using the same material as a sensing electrode or a touch electrode, as in the present embodiment, the coil part 410 may be formed although a separate process is not added.

Meanwhile, the first sensing electrode 210 and the first touch electrode 220 are formed in the first direction, and the second sensing electrode 310 and the second touch electrode 320 are formed in the second direction. In this case, the first direction and the second direction are relative directions in which a two-dimensional location is sensed. Preferably, the first direction and the second direction may be set as x-axis and y-axis directions, respectively. However, the first and the second directions do not need to be essentially vertical, and may be different directions in which two-dimensional coordinates can be obtained.

Meanwhile, in another embodiment of the present invention, the height of the coil part 410 may be formed to have the same height as the sensing electrode or touch electrode of a substrate on which the coil part 410 has been formed. Specifically, if the coil part 410 has been formed on the first substrate 200, it may have the same height as the first sensing electrode 210 or the first touch electrode 220. If the coil part 410 has been formed on the second substrate 300, it may have the same height as the second sensing electrode 310 or the second touch electrode 320. In the present embodiment, the meaning that the height is the same should be construed as including an error range which may be considered to be substantially the same height in structure in addition to the exact same height in number. For example, a range of about 5% in the height different is included in the same range. If the height of the coil part 410 is the same as that of the sensing electrode/touch electrode, a total thickness of a touch panel can be prevented from becoming thick due to the coil part 410. Furthermore, there is an advantage in that another element of a touch panel additionally formed over the sensing electrode, the touch electrode and the coil part 410 can be formed in the same height.

In a touch panel according to another embodiment of the present invention, the width of the coil part 410 is greater than that of the first, second sensing electrode or the width of the first, second touch electrode. As the width of the coil part 410 increases, electrical conductivity is improved. As a result, power to a stylus pen can be induced more smoothly. If the width of the sensing electrode or touch electrode is increased, there is a problem in that the visibility of a touch panel in the valid area is deteriorated or the sensing ability of the touch panel is reduced. Accordingly, the width of the sensing electrode or touch electrode is limited. However, the width of the coil part 410 of the present invention may be formed greater than that of the sensing electrode or touch electrode. Accordingly, the power supply ability can be improved.

In an embodiment of the present invention, the adhesive layer 500 formed between the cover substrate 100 and the first substrate 200 or between the first substrate 200 and the second substrate 300 may be further included. That is, the cover substrate 100 and the first substrate 200, and the first substrate 200 and the second substrate 300 may be coupled through the medium of the adhesive layer 500.

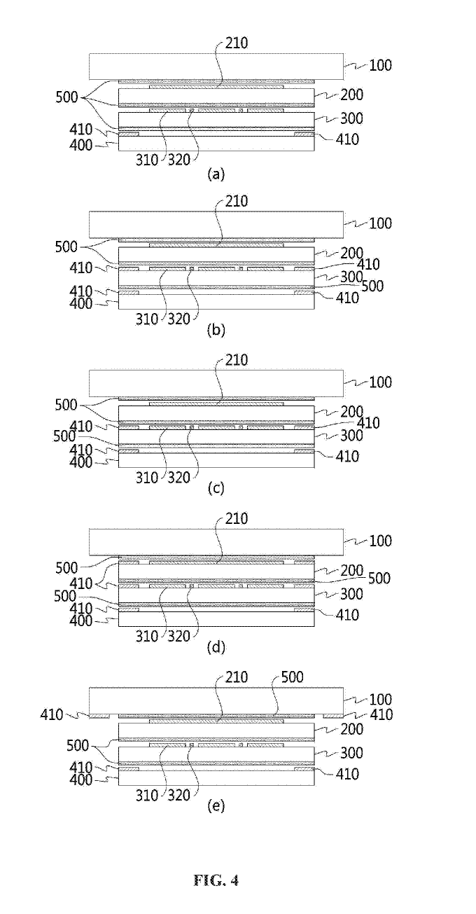

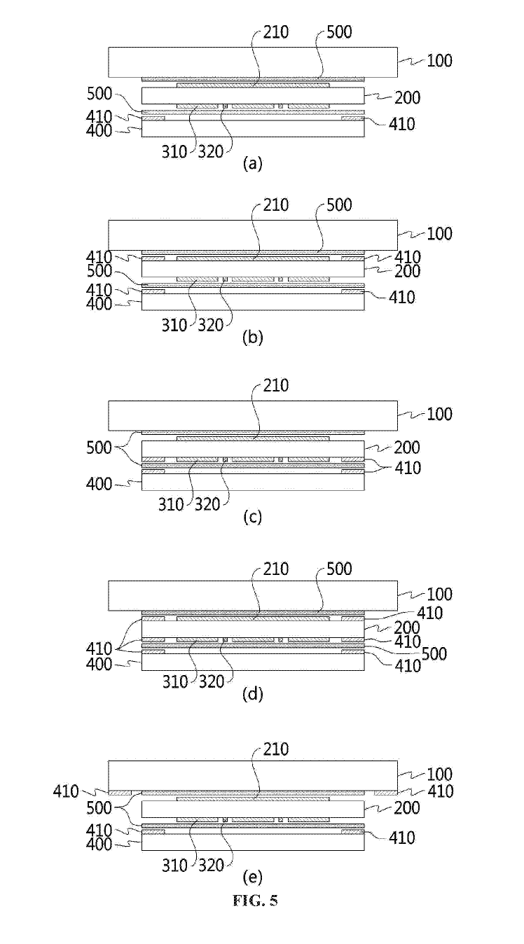

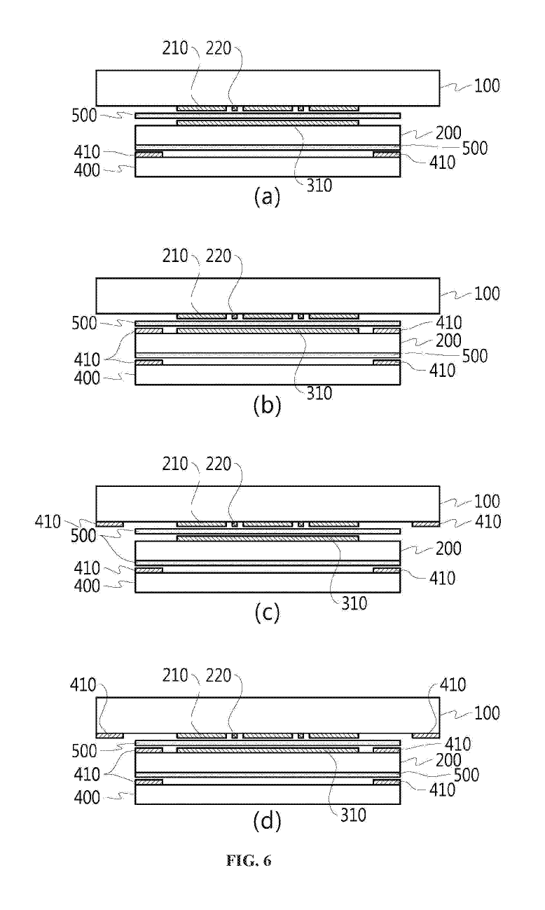

FIGS. 4 to 6 are cross-sectional views of examples in which a coil substrate is further included in the embodiments shown in FIGS. 1 to 3. In another embodiment of the present invention, the coil substrate 400 which is coupled to a substrate and in which a coil part has been formed in the invalid area may be further included. Meanwhile, the coil part may be formed of a plurality of loops.

The touch panel according to another embodiment of the present invention is described below.

A touch device according to an embodiment of the present invention may include a display panel coupled to a touch panel.

The display panel may be a liquid crystal display (LCD), an electrophoretic display or electric paper display (EPD), a plasma display panel device (PDP), a field emission display device (FED), an electroluminescence display device (ELD), an electro-wetting display (EWD), an organic light-emitting display (OLED) or the like. Accordingly, the display panel may be configured in various forms.

A light module may include a light source which emits light in the direction of the display panel. For example, the light source may include a light-emitting diode (LED) or an organic light-emitting diode (OLED).

The LCD may include a plurality of liquid crystal elements. These liquid crystal elements may have the directivity of a specific pattern because the arrangement of internal molecules is changed in response to an externally applied electric signal.

A driving unit may refract pieces of light in different patterns while the pieces of light emitted by the light module pass through the display panel. The driving unit may further include a polarization filter, a color filter, etc. disposed over the display panel. Alternatively, the driving unit may include only a light module without a display panel. For example, the driving unit may include only a light module including a light source that is individually driven in each pixel. Alternatively, the driving unit may include only a display panel without a light module. For example, a field emission display, a PDP, an organic light-emitting display (OLED), an EPD, etc. may include a light module in a display panel itself.

The touch panel may be disposed over the driving unit. Specifically, the touch panel may be received in a cover casing and disposed over the driving unit. The touch panel may be bonded to the driving unit. Specifically, the touch panel and the driving unit may be bonded together through an optical clear adhesive (OCA), optical clear resin (OCR), etc. However, an embodiment is not limited thereto, and the touch panel may be formed in an on-cell structure in which an electrode is directly formed on the driving unit without the adhesive or an in-cell structure in which the touch panel is disposed within the driving unit.

The display panel may be bonded to the touch panel through the adhesive layer. For example, the display panel and the touch panel may be bonded together through the adhesive layer including an OCA or OCR. In the touch panel of the present invention described with reference to FIGS. 1 to 6, the cover substrate and the display panel are not directly coupled, but the display panel and the touch panel may be coupled under the cover substrate, that is, under the first substrate, the second substrate or the coil substrate.

The touch panel according to another embodiment of the present invention includes a display panel. The display panel may include a first substrate and a second substrate. If the display panel is a liquid crystal display panel, the display panel may be formed in a structure in which the first substrate including a thin film transistor (TFT) and a pixel electrode and a second substrate including color filter layers are coalesced with a liquid crystal layer interposed therebetween.

Furthermore, the display panel may be a liquid crystal display panel of a color filter on transistor (COT) structure in which a TFT, a color filter and a black matrix are formed over a first substrate and a second substrate and the first substrate are coalesced with a liquid crystal layer interposed therebetween. That is, a thin film transistor may be formed on the first substrate, a passivation film may be formed on the thin film transistor, and a color filter layer may be formed on the passivation film. Furthermore, a pixel electrode coming into contact with the thin film transistor is formed in the first substrate. In this case, in order to improve an opening ratio and to simplify a mask process, the black matrix may be omitted and a common electrode may be formed to also function as the black matrix.

Furthermore, if the display panel is a liquid crystal display panel, the display device may further include a backlight unit which provides light at the back of the display panel.

If the display panel is an organic electroluminescent light-emitting display panel, the display panel includes a self-emissive element not requiring a separate light source. In the display panel, a TFT is formed on a first substrate, and an organic light-emitting element coming into contact with the TFT is formed. The organic light-emitting element may include a positive electrode, a negative electrode and an organic light-emitting layer formed between the positive electrode and the negative electrode. Furthermore, the organic light-emitting element may further include a second substrate functioning as a sealing substrate for encapsulation on the organic light-emitting element.

In the touch device according to the aforementioned embodiment, the display panel and the touch panel may be integrally formed. That is, in the aforementioned embodiment, the sensing electrode, the touch electrode and the coil part formed on at least one of the first substrate and second substrate of the touch panel may be formed on any one of the first substrate and the second substrate included in the display panel. In this case, at least one of the first and the second substrates formed within the touch panel may be omitted.

The sensing electrode, the touch electrode and the coil part may be disposed on one surface of the display panel. That is, the sensing electrode, the touch electrode or the coil part may be formed on the first substrate or second substrate of the display panel. In this case, at least one sensing electrode, the touch electrode and the coil part may be formed on the top surface of a substrate disposed on the upper side. That is, a sensing electrode may be formed on a surface of the display panel.

For example, a first sensing electrode, etc. may be formed over the first substrate of the display panel, and a second sensing electrode, etc. may be formed in the cover substrate of the touch panel or a substrate included in the touch panel. An adhesive layer may be disposed between the touch panel and the display panel, and thus the cover substrate and the display panel may be coupled through the medium of the adhesive layer.

Meanwhile, a polarization plate may be further included under the touch panel. The polarization plate may be a line polarization plate or an external light anti-reflection polarization plate. For example, if the display panel is a liquid crystal display panel, the polarization plate may be a line polarization plate. Furthermore, if the display panel is an organic electroluminescent display panel, the polarization plate may be an external light anti-reflection polarization plate. The touch device according to the present embodiment may omit at least one substrate supporting a sensing electrode within the touch panel. Accordingly, a touch device that is thin in thickness and light can be formed.

In another embodiment of the present invention, a touch panel integrally formed with a display panel may be included. That is, in the touch panel, at least one sensing electrode and a substrate supporting a touch electrode may be omitted.

That is, the sensing electrode and the substrate on which the touch electrode has been formed may be formed within the display panel.

The display panel includes a first substrate and a second substrate. In this case, at least one sensing electrode, a touch electrode or a coil part are disposed between the first substrate and the second substrate. That is, at least one sensing electrode may be disposed on at least one surface of the first substrate or the second substrate.

For example, a first sensing electrode and a second sensing electrode may be disposed on one surface of a cover substrate or a substrate included in a touch panel. Furthermore, a second sensing electrode and a second touch electrode may be formed between the first substrate and second substrate of the display panel. In this case, a coil part may be formed on at least one of the substrates on which the first and the second sensing electrodes and a touch electrode have been formed or may be formed in the touch panel, a separated substrate included in the display panel or the cover substrate. If a touch device is fabricated in the aforementioned structure, a process can be simplified and a cost can be reduced.

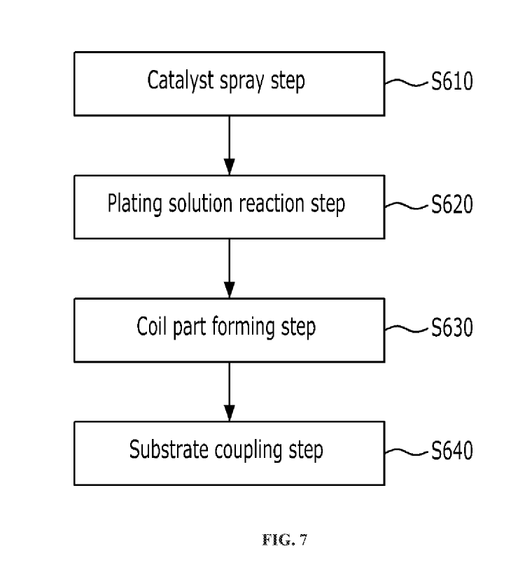

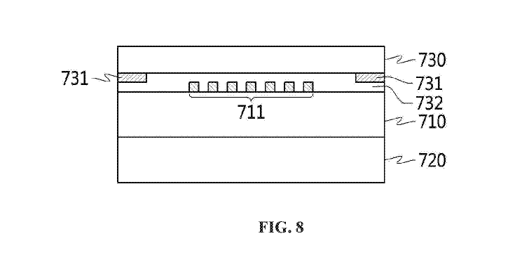

FIG. 7 is a flowchart schematically showing a method of manufacturing a touch panel according to another embodiment of the present invention, and FIG. 8 is a side view schematically showing a touch panel in which a coil part has been formed according to another embodiment of the present invention. As shown in FIGS. 7 and 8, the method of manufacturing a touch panel of the present invention according to another embodiment of the present invention is a method of forming a power coil functioning to supply power to a touch pen in a cover substrate 730 or a coil substrate 740 formed of a film in order for a resonant circuit embedded in the touch pen to resonate by externally supplied AC power in an electromagnetic induction method or an electromagnetic resonant method.

The method of manufacturing a touch panel according to another embodiment of the present invention includes a step (S610) of spraying a catalyst along a shape of a coil part on a cover substrate, a step (S620) of reacting the cover substrate on which the catalyst has been sprayed with a plating solution, a step (S630) of forming the coil part according to the reaction of the plating solution and the catalyst, and a step (S640) of combining the cover substrate on which the coil part has been formed with a substrate on which a sensing electrode has been formed.

First, in order to form the coil part 731 in the cover substrate 730, the catalyst is sprayed onto a location where the coil part 731 is to be formed on the cover substrate 730 in an inkjet method. In this case, the inkjet method used is a 3-step process of surface cleaning, printing and annealing, and can significantly reduce a process time compared to an existing photolithography process of coating photoresist on a glass substrate and performing exposure, development and cleaning processes. The inkjet method is a contactless patterning technology for spraying a solution or slurry in drops of several to several tens of pl through a fine nozzle.

Palladium (Pd) preferably is used as the catalyst sprayed by the inkjet method. When the catalyst is sprayed, the cover substrate 730 onto which the catalyst has been sprayed is immersed in the plating solution, and the coil part 731 is formed at the location where the catalyst has been sprayed. The catalyst sprayed by the inkjet method becomes a seed from which the coil part 731 is formed. The catalyst functions as a seed from which the coil part 731 is formed, and thus metal is plated on only the location where the catalyst has been sprayed, thereby forming the coil part 731.

Metal that forms the coil part 731 preferably is any one of copper (Cu), silver (Ag) and gold (Au), but may be metal oxide, such as indium tin oxide (ITO), indium zinc oxide (IZO), zinc oxide (ZnO), copper oxide, tin oxide, zinc oxide or titanium oxide, or various types of metal, including carbon nanotube (CNT), conductive polymer, graphene, copper (Cu), gold (Au), silver (Ag), aluminum (Al), titanium (Ti), nickel (Ni) or an alloy of them. In the catalyst spray step S610, when the cover substrate 730 onto which the catalyst (seed) of a low viscosity has been sprayed is immersed in the plating solution, the metal grows on the location where the catalyst (seed) has been sprayed at high speed, thereby forming the coil part 731.

When the coil part 731 is formed on the cover substrate 730, the cover substrate 730 on which the coil part 731 has been formed is attached to a substrate 710 on which a sensing electrode 711 for sensing a touch input has been formed, thus forming a touch panel. A control unit (not shown) for sensing and controlling a touch input, etc. are formed in the formed touch panel.

The cover substrate 730 is divided into a valid area and an invalid area surrounding the outside of the valid area. In the catalyst spray step S610, the catalyst is sprayed in the invalid area. In this case, a display may be displayed in the valid area, and a display may not be displayed in the invalid area. The location of an input device (e.g., a finger or a touch pen) may be sensed in at least one of the valid area and the invalid area.

A dummy layer may be formed in the invalid area of the cover substrate 730. The dummy layer may be formed by coating a material having a specific color so that a wiring electrode, a printed circuit board connecting the wiring electrode to an external circuit, etc. are not visible from the outside. The dummy layer may have a color suitable for a desired external appearance. For example, the dummy layer may include a black pigment or a white pigment and display black or white. Furthermore, a desired logo, etc. may be formed in the dummy layer using various methods. The coil part 731 may be disposed between the cover substrate 730 and the dummy layer and may be disposed between the dummy layer and the substrate 710 on which the sensing electrode 711 is disposed. Furthermore, the coil part 731 may be disposed on the cover substrate 730 of an area adjacent to the dummy layer disposed on the cover substrate 730.

In the catalyst spray step S610, the catalyst is preferably sprayed in the invalid area in a loop shape. Furthermore, in the substrate coupling step S640, the cover substrate 730 and the substrate 710 on which the sensing electrode has been formed are coupled through the medium of an adhesive layer. In this case, the cover substrate 730 may include chemically reinforced or semi-reinforced glass, such as soda lime glass or alumino silicate glass.

It is preferred that the coil part 731 and the sensing electrode 711 are formed on different substrates. However, if the coil part 731 and the sensing electrode 711 are formed using the same material and the cover substrate 730 and the substrate 710 are formed using the same material, the coil part 731 and the sensing electrode 711 may be formed on the same substrate. If the coil part 731 and the sensing electrode 711 are formed on the same substrate, the catalyst is sprayed onto an area in which the coil part 731 and the sensing electrode 711 are to be formed, and the substrate onto which the catalyst has been sprayed reacts to the plating solution, thereby forming the coil part 731 and the sensing electrode 711.

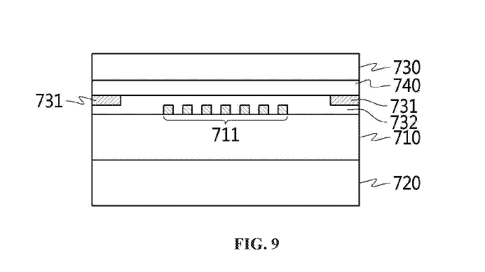

FIG. 9 is a side view schematically showing a touch panel in which a coil part has been formed according to yet another embodiment of the present invention. Referring to FIG. 9, the method of manufacturing a touch panel according to yet another embodiment of the present invention includes a step of spraying a catalyst along a shape of the coil part 731 on the coil substrate 740, a step of reacting the coil substrate 740 onto which the catalyst has been sprayed with a plating solution, a step of forming the coil part 731 according to the reaction of the plating solution and the catalyst, and a step of combining the coil substrate 740 on which the coil part 731 has been formed with a substrate on which the sensing electrode 711 has been formed.

In the method of manufacturing a touch panel according to yet another embodiment of the present invention, as in the method of forming the coil part 731 on the cover substrate 730, the catalyst is sprayed using an inkjet method. In this case, the coil substrate 740 is formed of a film made of at least any one of polyimide and polycarbonate. Furthermore, in this case, the coil substrate 740 may include reinforced or soft plastic, such as propylene glycol polyethylene terephthalate, or may include cyclic olefin copolymer (COC), cyclic olefin polymer (COP), optically isotropic polycarbonate or optically isotropic methacrylate (PMMA).

Palladium (Pd) is preferably used as the catalyst sprayed by the inkjet method. When the catalyst is sprayed, the coil substrate 740 onto which the catalyst has been sprayed is immersed in the plating solution, and the coil part 731 is formed at the location where the catalyst has been sprayed. The catalyst sprayed by the inkjet method becomes a seed from which the coil part 731 is formed. The catalyst functions as a seed from which the coil part 731 is formed, and thus metal is plated on only the location where the catalyst has been sprayed, thereby forming the coil part 731. In this case, metal that forms the coil part 731 is the same as the metal forming the coil part in FIGS. 7 and 8, and an overlapped description thereof is omitted.

When the coil part 731 is formed on the coil substrate 740, the coil substrate 740 is disposed between the substrate 710 on which the sensing electrode 711 for sensing a touch input has been formed and a display unit 720 and coupled thereto. A control unit (not shown) for sensing and controlling a touch input, a wiring electrode electrically connected to the sensing electrode 711, etc. are formed in the touch panel.

If the coil part 731 is formed on the coil substrate 740, when the cover substrate 730 has a curved surface or is a flexible material, there is an effect in that a process can be simplified because the cover substrate 730 can be easily attached to the coil substrate 740.

The cover substrate 730 is divided into a valid area and an invalid area surrounding the outside of the valid area. In the catalyst spray step S610, the catalyst is sprayed in the invalid area. In this case, a display may be displayed in the valid area, and a display may not be displayed in the invalid area. The location of an input device (e.g., a finger or a touch pen) may be sensed in at least one of the valid area and the invalid area.

A dummy layer may be formed in the invalid area of the cover substrate 730. The dummy layer may be formed by coating a material having a specific color so that a wiring electrode, a printed circuit board connecting the wiring electrode to an external circuit, etc. are not visible from the outside. The dummy layer may have a color suitable for a desired external appearance. For example, the dummy layer may include a black pigment, a white pigment, etc. and may display black or white. Furthermore, a desired logo, etc. may be formed on the dummy layer using various methods.

The coil part 731 and the sensing electrode 711 are preferably formed on different substrates. If the coil part 731 and the sensing electrode 711 are made of the same material and the coil substrate 740 and the substrate 710 are formed on films made of the same material, however, the coil part 731 and the sensing electrode 711 may be formed on the same substrate. If the coil part 731 and the sensing electrode 711 are formed on the same substrate, the catalyst is sprayed onto an area in which the coil part 731 and the sensing electrode 711 are to be formed, and the substrate onto which the catalyst has been sprayed reacts to the plating solution, thereby forming the coil part 731 and the sensing electrode 711.

The sensing electrode 711 has been illustrated as being formed on the single substrate 710 as shown in FIGS. 8 and 9, but not limited thereto. The sensing electrodes 711 according to the present invention may be formed on and below a single substrate and may be formed on two substrates, respectively. Furthermore, the sensing electrode 711 may be formed on the cover substrate 730.

The sensing electrode 711 may be formed in a mesh form. The sensing electrode 711 may include a plurality of sub-electrodes. The sub-electrodes may be disposed to cross each other in the mesh form.

The substrate 710 on which the sensing electrode 711 is formed may include chemically reinforced or semi-reinforced glass, such as soda lime glass or alumino silicate glass. Furthermore, the substrate 710 may include the same material as the coil substrate 740, and an overlapped description thereof is omitted. The substrate 710 may be bent while having a partially curved surface. That is, the substrate 710 may be bent while partially having a plane and partially having a curved surface. Specifically, the end of the substrate 710 may be bent while having a curved surface or may be bent or warped while having a surface including random curvature. Furthermore, the substrate 710 may be a flexible substrate having a flexible characteristic. Furthermore, the substrate 710 may be a curved or bent substrate. That is, a touch window including the substrate 710 may also be formed to have a flexible, curved or bent characteristic. Accordingly, the touch window according to the embodiment can be easily carried and can be changed in various designs.

The touch panel in which the coil part 731 has been formed on the cover substrate 730 or the coil substrate 740 is bonded to the display unit 720. The display unit 720 may be a liquid crystal display (LCD) or an organic light-emitting diode (OLED).

The sensing electrode 711 may be disposed in the display unit 720. In this case, the display unit 720 may include a first substrate and a second substrate. If the display unit 720 is a liquid crystal display panel, the display unit 720 may be formed in a structure in which the first substrate including a thin film transistor (TFT) and a pixel electrode and the second substrate including color filter layers have been coalesced with a liquid crystal layer interposed therebetween.

Furthermore, the display unit 720 may be a liquid crystal display panel of a color filter on transistor (COT) structure in which the TFT, color filters and a black matrix are formed on the first substrate and the second substrate and the first substrate are coalesced with the liquid crystal layer interposed therebetween. That is, the TFT may be formed on the first substrate, a passivation film may be formed on the TFT, and a color filter layer may be formed on the passivation film. Furthermore, a pixel electrode coming into contact with the TFT is formed on the first substrate. In this case, in order to improve an opening ratio and to simplify a mask process, the black matrix may be omitted and a common electrode may be formed to also function as the black matrix.

Furthermore, if the display unit 720 is a liquid crystal display panel, a backlight unit providing light at the back of the display unit 720 may be further included. If the display unit 720 is an organic electroluminescent display panel, the display unit 720 includes a self-emissive element not requiring a separate light source. In the display unit 720, a TFT is formed on a first substrate, and an organic light-emitting element coming into contact with the TFT is formed. The organic light-emitting element may include a positive electrode, a negative electrode, and an organic light-emitting layer formed between the positive electrode and the negative electrode. Furthermore, a second substrate functioning as a sealing substrate for encapsulation may be further formed on the organic light-emitting element.

In the touch device according to the aforementioned embodiment, the display unit 720 and a touch panel may be integrally formed. A sensing electrode and a touch electrode formed on at least one of the first substrate and second substrate of the touch panel may be formed on at least one of a first substrate and a second substrate included in the display unit 720. In this case, at least one of the first and the second substrates formed in the touch panel may be omitted.

The sensing electrode 711 may be disposed on one surface of the display unit 720. That is, the sensing electrode 711 may be formed on the first substrate or second substrate of the display unit 720. In this case, at least one sensing electrode 711 may be formed on the top surface of a substrate disposed on the upper side. That is, the sensing electrode 711, etc. may be formed on a surface of the display unit 720.

For example, a first sensing electrode, etc. may be formed on the first substrate of the display unit 720, and a second sensing electrode, etc. may be formed on the cover substrate 730 of the touch panel or a substrate included in the touch panel. An adhesive layer may be disposed between the touch panel and the display unit 720, and thus the cover substrate 730 and the display unit 720 may be coupled through the medium of the adhesive layer.

Meanwhile, a polarization plate may be further included under the touch panel. The polarization plate may be a line polarization plate or an external light anti-reflection polarization plate. For example, if the display unit 720 is a liquid crystal display panel, the polarization plate may be a line polarization plate. Furthermore, if the display unit 720 is an organic electroluminescent display panel, the polarization plate may be an external light anti-reflection polarization plate. In the touch device according to the present embodiment, at least one substrate supporting the sensing electrode within the touch panel may be omitted. Accordingly, a touch device that is thin in thickness and light can be formed.

Furthermore, the sensing electrode 711 may be formed within the display unit 720. The display unit 720 includes a first substrate and a second substrate. In this case, at least one sensing electrode and a touch electrode are disposed between the first substrate and the second substrate. That is, at least one sensing electrode may be disposed on at least one surface of the first substrate and the second substrate.

For example, a first sensing electrode and a second sensing electrode may be disposed on one surface of the cover substrate 730 or on a substrate included in a touch panel. Furthermore, a second sensing electrode and a second touch electrode may be formed between the first substrate and second substrate of the display unit 720. If a touch device is fabricated in the aforementioned structure, a process can be simplified and a cost can be reduced.

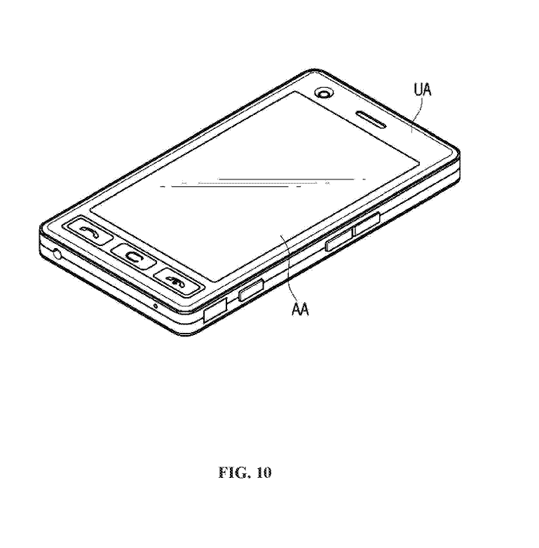

FIGS. 10 to 13 are diagrams showing examples to which the touch panel has been applied according to various embodiments of the present invention.

FIG. 10 shows that the touch panel of the present invention has been applied to a mobile device. The aforementioned touch panel may be applied to the display portion of the mobile device.

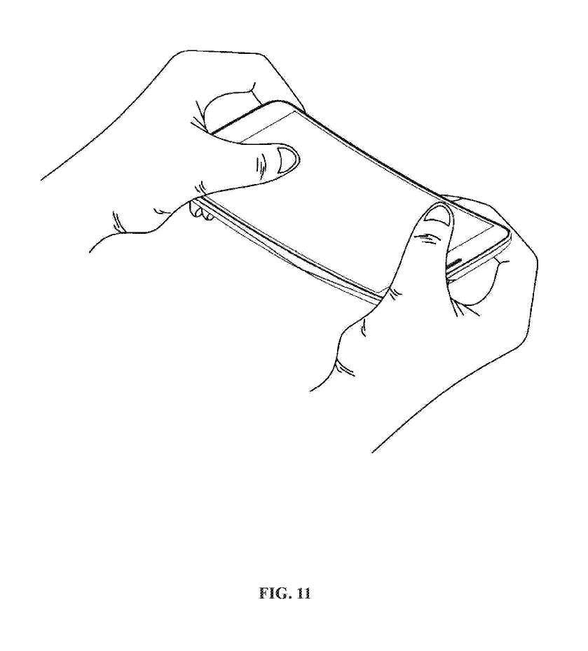

FIG. 11 shows a mobile device having a curved surface display from among mobile devices. In the present embodiment, a touch panel in which a substrate is bent while having a partially curved surface has been applied. For example, the touch panel may be a touch panel in which the substrate has been bent while partially having a plane and partially having a curved surface. Specifically, the end of the substrate may be bent while having a curved surface or may be bent or warped while having a surface including random curvature. Alternatively, the substrate itself may be a flexible substrate having a flexible characteristic. In addition, the substrate may be a curved or bent substrate. That is, a touch panel including the substrate may be formed to have a flexible, curved or bent characteristic. Accordingly, a mobile device to which the touch panel according to the embodiment has been applied can be easily carried and can be changed in various designs.

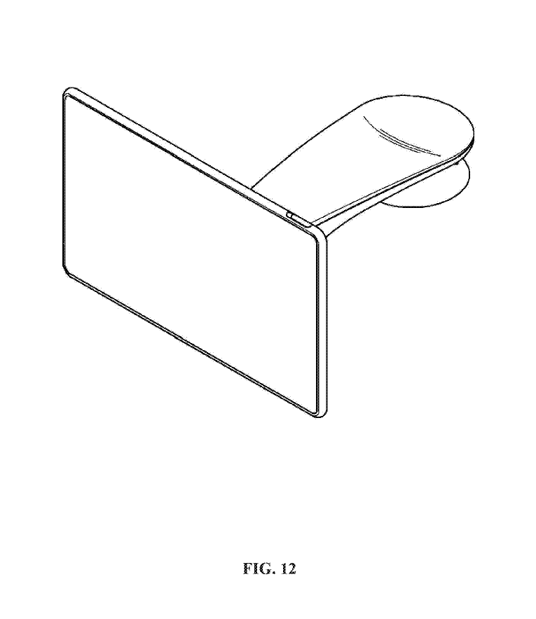

In FIG. 12, the touch panel according to an embodiment of the present invention has been detachably formed in another device by connection means. For example, the touch panel of the present invention may be applied to a navigator for vehicle, detachably mounted on a vehicle and used.

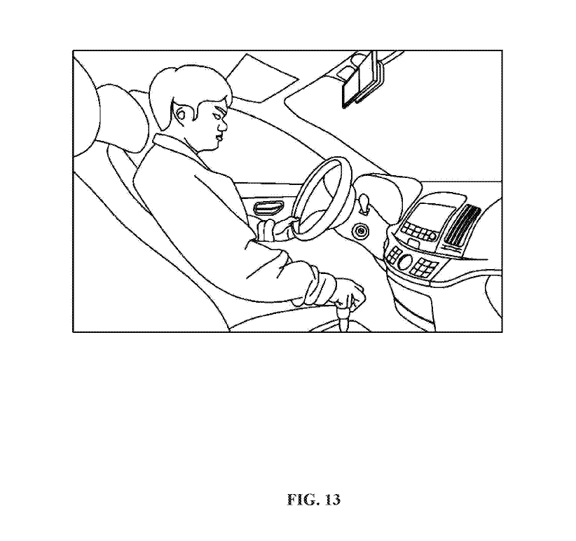

FIG. 13 is an example in which a display for vehicle has been implemented through the touch panel according to an embodiment of the present invention. The dash board and front manipulation unit in a vehicle may be implemented by the aforementioned touch panel.

The embodiments of the present invention have been disclosed for illustrative purposes, and portions that may be modified, changed and added by those skilled in the art to which the present invention pertains within the technological spirit of the present invention should be construed as belonging to the claims.

### DESCRIPTION OF REFERENCE NUMERALS

100, 200, 300 substrate

210 first sensing electrode

220 first touch electrode

310 second sensing electrode

320 second touch electrode

400 coil substrate

410 coil part

500 adhesive layer

710 substrate

721 sensing electrode

730 display unit

731 coil part

740 coil substrate

1. A touch panel, comprising:
a substrate having a valid area and an invalid area;
a sensing electrode formed in the valid area of the substrate and sensing touch input by an input device other than a stylus pen;
a touch electrode formed to not overlap the sensing electrode in the valid area of the substrate on which the sensing electrode is formed and sensing touch input by a stylus pen;
a wiring electrode formed in the invalid area of the substrate and connected to the sensing electrode;
a touch wiring electrode formed in the invalid area of the substrate and connected to the touch electrode; and
a coil part formed in the invalid area of the substrate, wherein one touch electrode is formed between adjacent sensing electrodes.

2. The touch panel of claim 1, wherein at least any one of the sensing electrode, the touch electrode, the wiring electrode, the touch wiring electrode and the coil part has a conductive pattern.

3. The touch panel of claim 2, wherein the conductive pattern comprises mesh lines and mesh opening parts.

4. The touch panel of claim 1, wherein the substrate comprises:
a first substrate on which a first sensing electrode and a first touch electrode are formed; and
a second substrate on which a second sensing electrode and a second touch electrode are formed.

5. The touch panel of claim 4, further comprising a cover substrate on which a dummy layer is formed in the invalid area.

6. The touch panel of claim 4, wherein:
a dummy layer is formed in the invalid area of the first substrate, and
the wiring electrode or the touch wiring electrode are formed over the dummy layer.

7. The touch panel of claim 6, wherein the coil part is formed under the dummy layer or formed to not overlap the wiring electrode and the touch wiring electrode over the dummy layer.

8. The touch panel of claim 1, wherein:
a first sensing electrode and a first touch electrode are fowled on one surface of the substrate, and
a second sensing electrode and a second touch electrode are formed on the other surface of the substrate.

9. The touch panel of claim 1, wherein the sensing electrode, the touch electrode and the coil part are made of an identical electrode material.

10. The touch panel of claim 1, wherein a height of the coil part is identical to a height of the sensing electrode or the touch electrode.

11. The touch panel of claim 1, wherein a width of the coil part is greater than a width of the sensing electrode or touch electrode.

12. The touch panel of claim 4, wherein the coil part is formed on at least one or more of a surface on which the first sensing electrode and the first touch electrode are formed on the first substrate and a surface on which the second sensing electrode and the second touch electrode are formed on the second substrate.

13. The touch panel of claim 1, further comprising a coil substrate which is coupled to the substrate and on which the coil part has been formed in the invalid area.

14. The touch panel of claim 1, wherein the coil part comprises a plurality of loops.
